(19) United States
(12) Patent Application Publication
(10) Pub. No.: US 2014/0235884 A1
(43) Pub. Date: Aug. 21, 2014

(54) METHOD OF PREPARING SILICON NANOCRYSTALS

(71) Applicant: THE GOVERNORS OF THE UNIVERSITY OF ALBERTA, Edmonton (CA)

(72) Inventors: Jonathan G.C. Veinot, St. Albert (CA); Mita Dasog, Edmonton (CA)

(73) Assignee: THE GOVERNORS OF THE UNIVERSITY OF ALBERTA, Edmonton (CA)

(21) Appl. No.: 14/183,564

(22) Filed: Feb. 19, 2014

Related U.S. Application Data
(60) Provisional application No. 61/766,945, filed on Feb. 20, 2013.

(51) Int. Cl. C01B 33/023; C01B 33/04; C07F 9/28

(52) U.S. Cl. CPC C01B 33/023; C07F 9/28; C01B 33/043
USPC 556/405; 423/350; 423/347

(57) ABSTRACT

The present application includes a method of preparing silicon nanocrystals (Si-NCs) comprising combining silica particles with magnesium and heating said combination under conditions to form Si-NCs, wherein the silica particles are obtained using sol gel chemistry.

### CROSS-REFERENCE TO RELATED APPLICATIONS

The present application claims the benefit of priority from co-pending U.S. provisional application No. 61/766,945 filed on Feb. 20, 2013, the contents of which are incorporated herein by reference in their entirety.

### FIELD

The present application relates to a novel method of preparing silicon nanocrystals.

### BACKGROUND

Silicon nanocrystals (Si-NCs) have become a material of significant interest recently due to their unique optoelectronic properties¹, biocompatibility², and abundance. Si-NCs may be prepared using physical methods such as ion implantation³, vacuum evaporation⁴, and sputtering⁵. These methods often require costly infrastructure and are impractical for making large quantities of material. Si-NCs can also be prepared chemically via solution phase methods, however such syntheses often employ somewhat specialized precursors and can have pyrophoric side products^{6,7,8}. In addition, Si-NCs obtained from these procedures are polydisperse, amorphous, and can require high temperature annealing to induce crystallinity.

Solid-state synthesis of Si-NCs from silicon rich oxide (SRO) precursors has gained substantial interest due to its ease and scalability^{9,10,11}. These syntheses use high temperatures (i.e., T>1000° C.) to induce disproportionation of SROs to yield substantial silicon oxide and oxide-embedded Si-NCs. Unfortunately, the atom economy of these procedures is poor. Only approximately one quarter of the available silicon in the precursor is converted into elemental silicon (i.e., 4SiO_{1.5}3SiO₂+Si). In addition, disproportionation of SROs allows preparation of Si-NCs only in the size regime of about 3-15 nm and as particle dimension increases so does the size polydispersityl¹². To date, no reports describing the synthesis of large Si-NCs with a narrow size distribution have appeared.

The synthesis of silicon nitride NCs using a magnesiothermic reduction method has been reported¹³. This method has also been used to make Si thin films¹⁴, hollow spheres¹⁵ and microstructures.¹⁶

Silica NCs have also been prepared by the reduction of commercial amorphous nanosilica by magnesium at high temperatures¹⁷.

### SUMMARY

In the present application, a straightforward method of preparing silicon nanocrystals (Si-NCs) having a wide range of sizes using magnesiothermic reduction has been shown. The Si-NCs were treated with hydrofluoric acid to provide hydride terminated Si-NCs. The hydride terminated Si-NCs were then further reacted with trioctylphosphine oxide (TOPO) to yield hydroxyl terminated TOPO encapsulated Si-NCs that exhibit red luminescence.

Accordingly, the present application includes a method of preparing silicon nanocrystals (Si-NCs), the method comprising:
(a) combining silica particles with magnesium; and
(b) heating the combination in step (a) under conditions to form Si-NCs,
wherein the silica particles are obtained using sol gel chemistry.

In an embodiment of the application, the silica particles are Stober silica particles.

The present application also includes a method of preparing hydride terminated Si-NCs, the method comprising treating Si-NCs prepared by a method of the present application with hydrofluoric acid under conditions to form hydride terminated Si-NCs.

The present application further includes a method of preparing hydroxyl-terminated Si-NCs functionalized with a trialkylphosphine oxide, the method comprising treating hydride terminated Si-NCs prepared by a method of the present application with a suitable trialkylphosphine oxide under conditions to form hydroxyl-terminated Si-NCs functionalized with a trialkylphosphine oxide.

In a further embodiment of the present application, the hydride terminated or hydroxyl terminated SiNCs are further treated under conditions to incorporate other functional groups on to the surface. In yet another embodiment, the surface modification changes the photoluminescent, mechanical and/or thermal properties of SiNCs. Other functional groups that may be incorporated onto the surface of the Si-NCs prepared using a method of the present application, include, for example, allylamine groups which are known to provide Si-NCs that exhibit blue luminescence.¹⁸

The present application also includes Si-NC's prepared using the methods of the present application as well as an apparatus or device comprising the Si-NC's prepared using the methods of the present application.

Other features and advantages of the present application will become apparent from the following detailed description. It should be understood, however, that the detailed description and the specific examples while indicating embodiments of the application are given by way of illustration only, since various changes and modifications within the spirit and scope of the application will become apparent to those skilled in the art from this detailed description.

### BRIEF DESCRIPTION OF THE DRAWINGS

The present application will now be described in greater detail with reference to the drawings in which:

FIG. 1 shows the evolution of Stöber silica particle size as a function of reaction time according to an embodiment of the present application.

FIG. 2 shows a synthetic approach to hydroxyl terminated Si-NCs functionalized with a trialkylphosphine oxide according to an embodiment of the present application.

FIG. 3 shows exemplary scanning electron micrograph (SEM) images of Stöber silica particles of averages sizes of about (A) 15 nm (B) 40 nm (C) 75 nm (D) 95 nm (E) 145 nm and (F) 200 nm for use in an embodiment of the present application. The scale bar represents 200 nm.

FIG. 4 shows exemplary transmission electron microscopy (TEM) images of about (A) 15 nm and (B) 40 nm Stöber silica particles for use in an embodiment of the present application.

FIG. 5 shows exemplary powder X-ray diffraction patterns of about (A) 4 nm (B) 9 nm (C) 20 nm (D) 32 nm (E) 45 nm and (F) 70 nm Si-NCs, respectively prepared using a method according to an embodiment of the present application.

FIG. 6 shows an exemplary FTIR spectrum of hydride terminated Si-NCs prepared using a method according to an embodiment of the present application.

FIG. 7 shows exemplary transmission electron micrograph (TEM) images of about (A) 3.8 nm (B) 23 nm (C) 75 nm (D) 110 nm (E) 177 nm, Si-NCs prepared using a method according to an embodiment of the present application. FIG. 7F shows an exemplary selected area electron diffraction (SAED) pattern for the 110 nm Si-NCs. The d-spacing for (111), (220) and (311) Miller indices are 3.24 Å, 1.93 Å and 1.69 Å, respectively. FIG. 7G shows an exemplary energy dispersive X-ray (EDX) spectrum of the 110 nm Si-NC sample. EDX analysis of all the Si-NCs showed very similar spectra.

FIG. 8 shows exemplary SEM images of about (A) 75 nm (B) 110 nm and (C) 177 nm silicon nanocrystals prepared using a method according to an embodiment of the present application. The scale bar is 1 μm.

FIG. 9 shows an exemplary FTIR spectrum of hydroxyl terminated Si-NCs prepared using a method according to an embodiment of the present application.

FIG. 10A shows an exemplary image of hydroxyl terminated, TOPO functionalized Si-NCs prepared using a method according to an embodiment of the present application under UV illumination. FIG. 10B shows an exemplary photoluminescence (PL) spectrum of red emitting Si-NCs prepared according to an embodiment of the present application. FIG. 10C shows an exemplary absorbance spectrum of red-emitting Si-NCs prepared according to an embodiment of the present application.

### DETAILED DESCRIPTION

I. Definitions

Unless otherwise indicated, the definitions and embodiments described in this and other sections are intended to be applicable to all embodiments and aspects of the application herein described for which they are suitable as would be understood by a person skilled in the art.

As used in the present application, the singular forms “a”, “an” and “the” include plural references unless the content clearly dictates otherwise. For example, an embodiment including “a trialkylphosphine oxide” should be understood to present certain aspects with one trialkylphosphine oxide, or two or more additional trialkylphosphine oxides.

In embodiments comprising an “additional” or “second” component, such as an additional or second trialkylphosphine oxide, the second component as used herein is chemically different from the other components or first component. A “third” component is different from the other, first, and second components, and further enumerated or “additional” components are similarly different.

The term “suitable” as used herein means that the selection of the particular compound or conditions would depend on the specific synthetic manipulation to be performed, and the identity of the species to be transformed, but the selection would be well within the skill of a person trained in the art. All method steps described herein are to be conducted under conditions sufficient to provide the desired product. A person skilled in the art would understand that all reaction conditions, including, for example, reaction solvent, reaction time, reaction temperature, reaction pressure, reactant ratio and whether or not the reaction should be performed under an anhydrous or inert atmosphere, can be varied to optimize the yield of the desired product and it is within their skill to do so.

In understanding the scope of the present application, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. The term “consisting” and its derivatives, as used herein, are intended to be closed terms that specify the presence of the stated features, elements, components, groups, integers, and/or steps, but exclude the presence of other unstated features, elements, components, groups, integers and/or steps. The term “consisting essentially of”, as used herein, is intended to specify the presence of the stated features, elements, components, groups, integers, and/or steps as well as those that do not materially affect the basic and novel characteristic(s) of features, elements, components, groups, integers, and/or steps.

Terms of degree such as “substantially”, “about” and “approximately” as used herein mean a reasonable amount of deviation of the modified term such that the end result is not significantly changed. These terms of degree should be construed as including a deviation of at least ±5% of the modified term if this deviation would not negate the meaning of the word it modifies or unless the context suggests otherwise to a person skilled in the art.

The term “sol gel chemistry” as used herein refers to a chemical procedure in which a “sol” or solution gradually evolves towards the formation of a gel-like diphasic system containing both a liquid phase and a solid phase. Precursors for the formation of silica particles using sol gel chemistry are typically silicon alkoxides (Si(OR)₄, wherein R is, for example C₁₋₄alkyl) and silicon chlorides (SiCl₄), which undergo hydrolysis and polycondensation reactions to form a silica network having the formula SiOₓ comprising Si—O—Si linkages. The hydrolysis and polycondensation reactions are either acid or base-catalyzed. In an embodiment, these reactions are base catalyzed which favours the formation of monodisperse silica particles.

The term “monodisperse silica particles” as used herein refers to silica particles having uniform size and shape.

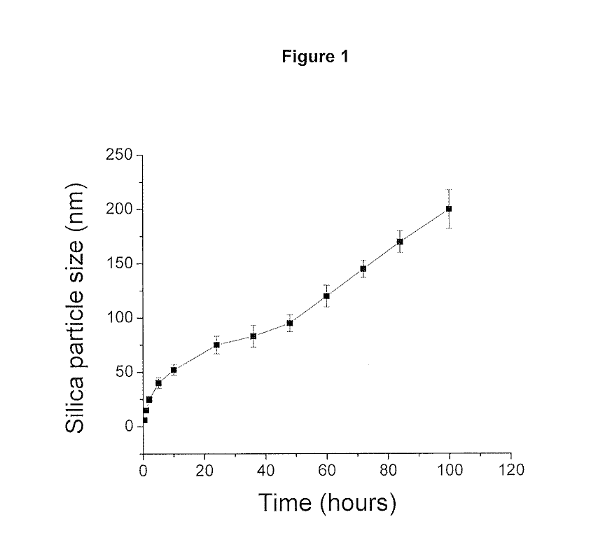

The term “Stöber silica particles” as used herein refers to silica particles prepared using a base catalyzed sol-gel chemistry, for example the base catalyzed sol-gel reaction of a tetraalkoxysilane such as tetraethoxysilane (TEOS).¹⁹ The selection of conditions to prepare Stöober silica particles having a desired particle size can be made by a person skilled in the art, particularly with reference to the examples of the present application. For example, a suitable tetraalkoxysilane can be stirred with a low molecular weight alcohol, water, for example deionized water and NH₄OH solution, for example an about 42% NH₄OH solution under conditions to form Stöber silica particles. The Stöber silica particle size can be tailored, for example, by controlling the reaction time as described in the examples and shown in FIG. 1 and Table 1. In an embodiment of the present application, the tetraalkoxysilane is a tetraC₁₋₆alkoxysilane. In another embodiment, the tetraC₁₋₆alkoxysilane is tetraethoxysilane. In another embodiment of the present application, the low molecular weight alcohol is a C₁₋₆alkyl-OH. It is an embodiment that the C₁₋₆alkyl-OH is ethanol.

The term “alkyl” as used herein, whether it is used alone or as part of another group, means straight or branched chain, saturated alkyl groups. The term C₁₋₆alkyl means an alkyl group having 1, 2, 3, 4, 5 or 6 carbon atoms.

The term “alkoxy” as used herein, whether it is used alone or as part of another group, means straight or branched chain, saturated alkoxy groups. The term C₁₋₆alkoxy means an alkyl group having 1, 2, 3, 4, 5 or 6 carbon atoms.

II. Methods of the Present Application

In the present application, size-controlled Stöber silica particles were prepared using sol-gel chemistry. The Stöber silica particles were subsequently reduced using magnesium powder at about 500 ° C. to yield silicon nanocrystals (Si-NCs). Si-NCs in the size regime of about 4 to about 170 nm were made using this method. Magnesiothermic reduction offers a straightforward way to convert silica (inexpensive and the most stable source of Si) into elemental silicon while retaining silica particle morphology. After the reduction, the resulting Si-NCs were rendered luminescent in the visible spectral region by reacting hydride terminated Si-NCs with trioctylphosphine oxide (TOPO) to yield hydroxyl terminated, TOPO functionalized Si-NCs that exhibit red luminescence. This is the first report demonstrating the visible luminescence from Si-NCs with dimensions larger than 15 nm.

Accordingly, the present application includes a method of preparing silicon nanocrystals (Si-NCs), the method comprising:
(a) combining silica particles with magnesium; and
(b) heating the combination in step (a) under conditions to form Si-NCs,
wherein the silica particles are obtained using sol gel chemistry.

In an embodiment of the present application, the conditions to form Si-NCs comprise a temperature of about 450° C. to about 650° C., or about 500° C. and a time of about 24 hours to about 6 hours, or about 15 hours. The resulting powder can then be treated for a time of about 20 minutes to about 1 hour, or about 30 minutes with a suitable acid, for example, concentrated hydrochloric acid to remove magnesium oxide.

In an embodiment, the silica particles are Stöber silica particles. In an embodiment, the Stöber silica particles have a particle size of about 5 nm to about 1 μm or about 6 μm to about 200 μm. In another embodiment, the Stöber silica particles have a particle size of about 6 μm, about 15 μm, about 25 μm, about 40 μm, about 52 μm, about 75 μm, about 83 μm, about 95 μm, about 120 μ m, about 145 μm, about 170 μm or about 200 μm.

In another embodiment, the magnesium is magnesium powder. In another embodiment, the molar ratio of the Stöber silica particles (based on Si) to the magnesium is from about 1:2 to about 1:3 or about 1:2.2.

The Si-NCs prepared by the method of the present application can be treated with hydrofluoric acid to form hydride terminated Si-NCs. Accordingly, the present application also includes a method of preparing hydride terminated Si-NCs comprising treating Si-NCs prepared by the method of the present application with hydrofluoric acid under conditions to form hydride terminated Si-NCs. In an embodiment, the conditions to form hydride terminated Si-NCs comprise stirring a suspension of Si-NCs in a solution of HF:H₂O:ethanol, for example, an about 1:1:1 solution of about 49% HF(_{aq}):H₂O:ethanol at a temperature of about 20 ° C. to about 30 ° C. or about 25 ° C. for a time of about 5 minutes to about 2 hours or about 60 minutes.

In an embodiment, the Si-NCs have a particle size estimated by XRD of about 4 nm to about 1 μm, or about 4 nm to about 70 nm. In another embodiment, the Si-NCs have a particle size estimated by XRD of about 4 nm, about 9 nm, about 20 nm, about 32 nm, about 45 nm or about 70 nm.

In an embodiment, the Si-NCs have a particle size estimated by TEM of about 4 nm to about 1 μm, or about 3.8 nm to about 177 nm. In another embodiment, the Si-NCs have a particle size estimated by TEM of about 3.8 nm, about 8.8 nm, about 23 nm, about 35 nm, about 45 nm, about 67 nm, about 75 nm, about 88 nm, about 110 nm, about 132 nm, about 150 nm or about 177 nm.

The hydride terminated Si-NCs prepared by a method of the present application can be treated with a trialkylphosphine oxide under conditions to form hydroxyl-terminated Si-NCs functionalized with the trialkylphosphine oxide. While not wishing to be limited by theory, functionalization of the hydride-terminated Si-NCs in this manner encapsulates and stabilizes the Si-NC's, and allows for their dissolution in organic solvents. Accordingly, the present application further includes a method of preparing hydroxyl-terminated Si-NCs functionalized with a trialkylphosphine oxide comprising treating hydride terminated Si-NCs prepared by a method of the present application with a suitable trialkylphosphine oxide under conditions to form hydroxyl-terminated Si-NCs functionalized with a trialkylphosphine oxide. In an embodiment, the conditions to form hydroxyl-terminated Si-NCs functionalized with a trialkylphosphine oxide comprise treating the hydride terminated Si-NCs with an excess amount of a suitable trialkylphosphine oxide at a temperature of about 25° C. for a time of about 4 hours to about 24 hours or about 12 hours. In an embodiment, the trialkylphosphine oxide is a tri(C₆-C₁₂alkyl)phosphine oxide. In another embodiment, the tri(C₈-alkyl)phosphine oxide is trioctylphosphine oxide.

In a further embodiment of the present application, the hydride terminated or hydroxyl terminated SiNCs are further treated under conditions to incorporate other functional groups on to the surface. In yet another embodiment, the surface modification changes the photoluminescent, mechanical and/or thermal properties of SiNCs. Other functional groups that may be incorporated onto the surface of the Si-NCs prepared using a method of the present application, include, for example, allylamine groups which are known to provide Si-NCs that exhibit blue luminescence.¹⁸ Allylamine groups are added to hydride terminated Si-NC's, for example by reaction with PCl₃ to prepare the corresponding chloride terminated Si-NC's which are subsequently reacted with allylamine under conditions to form allylamine terminated Si-NCs.

In yet another embodiment, surface modification is selected from reacting alkenes and organosilanes with surface hydroxyl groups, using Grignard reagents and alkyl or aryl lithium reagents and transition metal mediated dehydrogenative coupling reactions. In another embodiment unsaturated functional groups on the surface are further reacted with diazo groups.

### EXAMPLES

### Example 1

### Size-Controlled Solid State Synthesis of Luminescent silicon nanocrystals

### (a) Materials and Methods

### Reagents

Tetraethoxysilane (TEOS, 99%, Sigma-Aldrich), ammonium hydroxide (NH₄OH, 42%, Caledon), magnesium powder (Mg, 99%, BDH), toluene (ACS grade, BDH), ethanol (ACS grade, Sigma-Aldrich), hydrofluoric acid (HF, 49%, J. T. Baker), trioctylphosphine oxide (TOPO, 97%, Sigma-Aldrich) were used as received.

Synthesis of Stöber silica Particles

Stöber silica particles were synthesized via a base catalyzed sol-gel method. Briefly, TEOS (10 mL, 45 mmol) was stirred with ethanol (10 mL), deionized water (20 mL) and NH₄OH solution (42%, 5 mL) for varying times (Table 1) to yield different sized particles. The white precipitate was collected by vacuum filtration and washed with deionized water multiple times (4×25 mL). The solid was transferred to an oven and was kept there for 24 hours at 100 ° C. to drive off any residual water and ethanol.

Synthesis of silicon nanocrystals (Si-NCs)

Silica particles (1.00 g, 17 mmol w.r.t Si content) and magnesium powder (0.87 g, 36 mmol) were mixed together manually and thermally processed at 500° C. for 15 hours under argon atmosphere. The resulting greyish brown powder was treated with concentrated hydrochloric acid (5 mL) for 30 min to remove magnesium oxide (MgO). The brown precipitate was obtained by vacuum filtration. The solid was washed with deionized water until the washings had a neutral pH (ca. 7). This was followed by washing with ethanol (20 mL) and acetone (3×20 mL) and was air dried to yield oxide coated Si-NCs.

Synthesis of hydride Terminated Si-NCs

The composite obtained by the procedure above was treated with hydrofluoric acid to remove the protective SiO₂ layer. In a typical etching procedure, 0.5 g of the sample was transferred to a Teflon test tube and a 1:1:1 solution of 49% HF(_{aq}):H₂O:ethanol (10 mL) was added. The mixture was stirred for 60 min at a temperature of about 25° C. followed by extraction into 10 mL toluene. The free standing nanocrystals were washed multiple times with toluene by centrifugation at 32000 rpm.

Functionalization of Si-NCs with TOPO

Hydride terminated Si-NCs (100 mg) were stirred together with TOPO (13.8 g, 36 mmol) in toluene (20 mL) for 12 hours under ambient conditions. After the completion of the reaction, the solution turned a clear light yellow color from a cloudy orange dispersion. The attempts to remove excess TOPO led to precipitation of the Si-NCs from the solution. While not wishing to be limited by theory, it is believed that excess TOPO is required to encapsulate hydroxyl Si-NCs within a TOPO micelle to render them solution dispersible.

### Characterization

Fourier Transformation Infrared Spectroscopy (FTIR) was performed on Nicolet Magna 750 IR spectrometer. X-ray powder diffraction (XRD) patterns were collected using an INEL XRG 3000 X-Ray diffractometer with CuK₆₀ radiation (λ=154 Å). Photoluminescence spectra for the solution phase samples were acquired using a Varian Cary Eclipse Fluorescence Spectrometer. Transmission electron microscopy (TEM) analyses were performed using a JOEL-2010 (LaB₆ filament) with an accelerating voltage of 200 keV. The samples were prepared by drop coating solutions of composite or free standing Si-NCs dispersed in ethanol and toluene, respectively onto a carbon coated copper grid (400 mesh) and allowing the solvent to evaporate in air. The particle sizes were measured using Image J software. Scanning electron microscopy (SEM) was performed on a JSM-6010LA In TouchScope instrument. The powder sample was mounted on carbon tape for imaging.

### (b) Results and Discussion

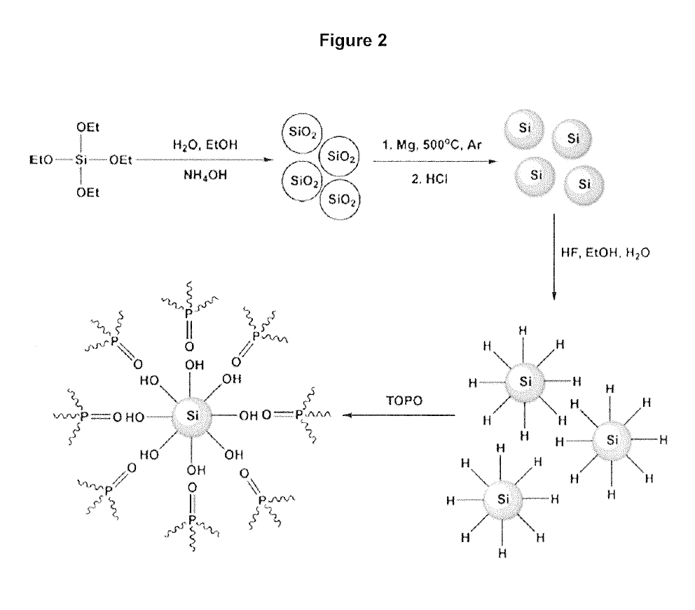

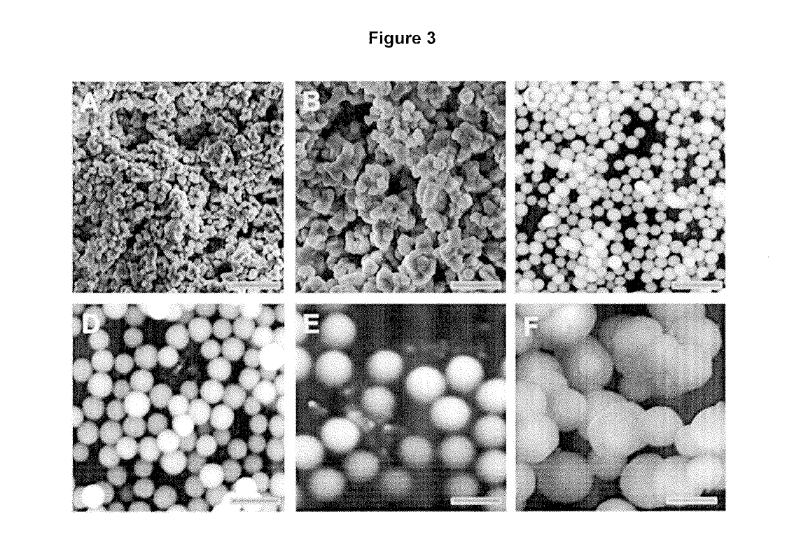

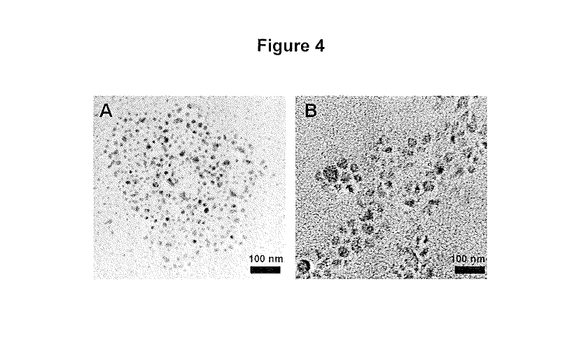

FIG. 2 provides an overview of the synthetic approach discussed in the following paragraphs. Stober silica particles were prepared via base catalyzed sol-gel reactions of tetraethoxysilane (TEOS) as described above. The silica particle size was tailored by controlling the reaction time (FIG. 1, Table 1). Scanning electron micrograph (SEM) images of representative silica particles synthesized in this way are shown in FIG. 3. Transmission electron micrograph (TEM) images for the about 15 and 40 nm silica particles are shown in FIG. 4.

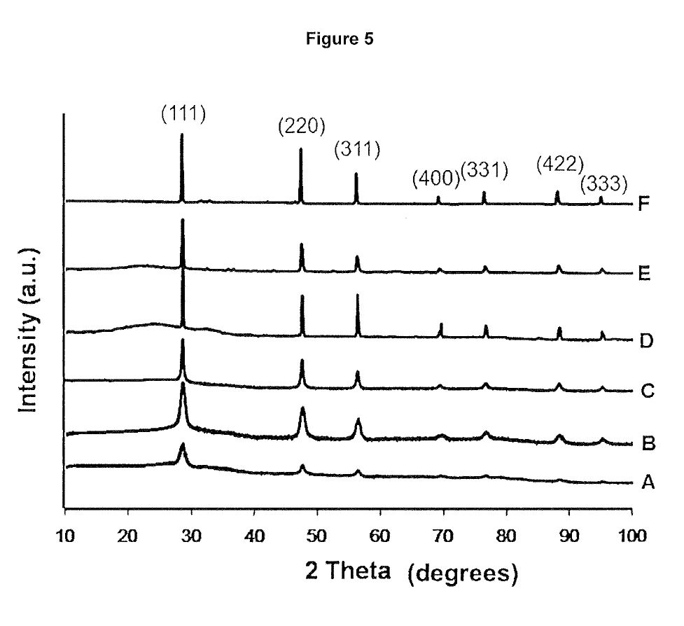

The silica particles were mechanically mixed with about stoichiometric amounts of magnesium powder and the mixture was annealed at 500 ° C. in a flowing argon atmosphere.²⁰ The resulting composite was treated with hydrochloric acid to remove magnesium oxide and any unreacted Mg powder. The formation of crystalline Si was confirmed using powder X-Ray diffraction which showed characteristic peaks for diamond structure of Si (FIG. 5).9 A broad peak at ca. 20° arising from surface oxide was also observed.

The sizes of Si-NCs prepared in this way were slightly smaller than the parent silica particles as can be seen in Table 2.

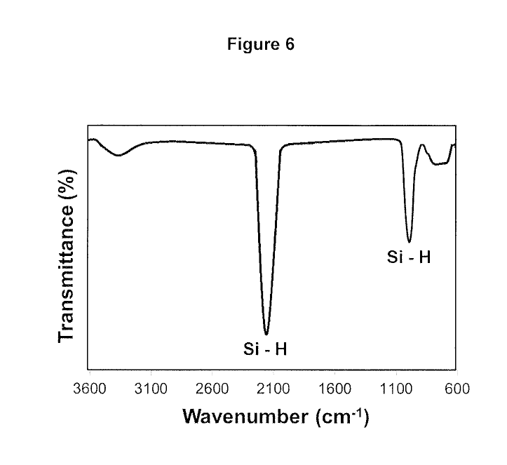

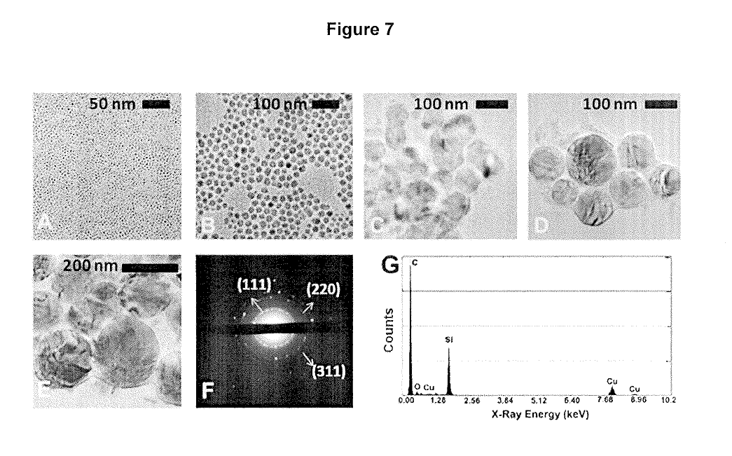

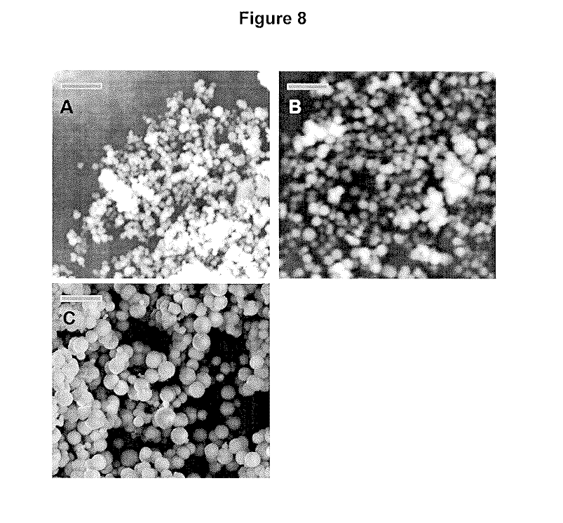

Freestanding hydride terminated Si-NCs were obtained by reacting Si-NCs with a 1:1:1 mixture of hydrofluoric acid, ethanol and water followed by extraction into toluene. The FTIR spectrum shows characteristic Si—Hₓ stretching at ca. 2100 and 910 cm⁻¹ (FIG. 6).9 The transmission electron microscopy (TEM) images, representative selected area electron diffraction (SAED) and energy dispersive X-Ray (EDX) spectra of freestanding Si-NCs are shown in FIG. 7. SEM images of the larger Si-NCs are shown in FIG. 8. The absence of a substantial oxygen signal in EDX confirms the substantially complete

reduction of the silica. No magnesium was detected at the sensitivity of the EDX method, which is consistent with a substantially complete removal of any byproducts or unreacted Mg metal.

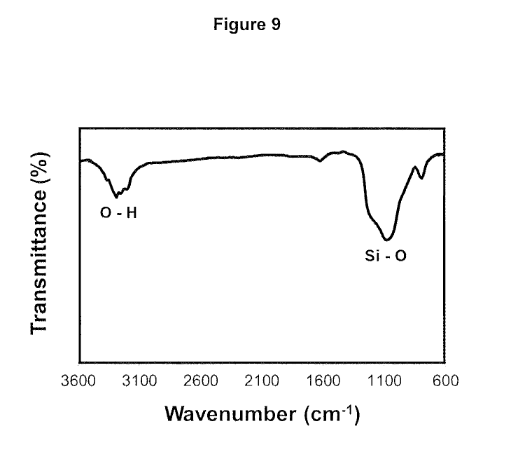

The hydride terminated Si-NCs were reacted with excess trioctylphosphine oxide (TOPO) to render them compatible with standard organic solvents. It was found that TOPO reacts with the hydride surface of Si-NCs to yield hydroxyl terminated Si-NCs. This was confirmed by FTIR as can be seen in FIG. 9.²¹ The proposed mechanism for the reaction between TOPO and hydride terminated Si-NCs is shown in Scheme 1.

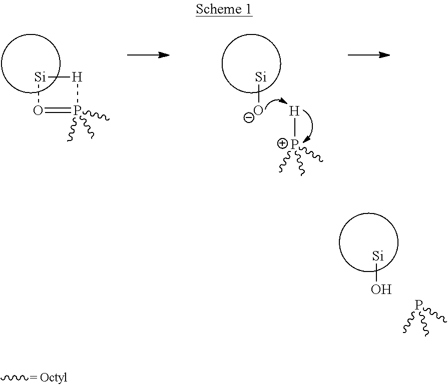

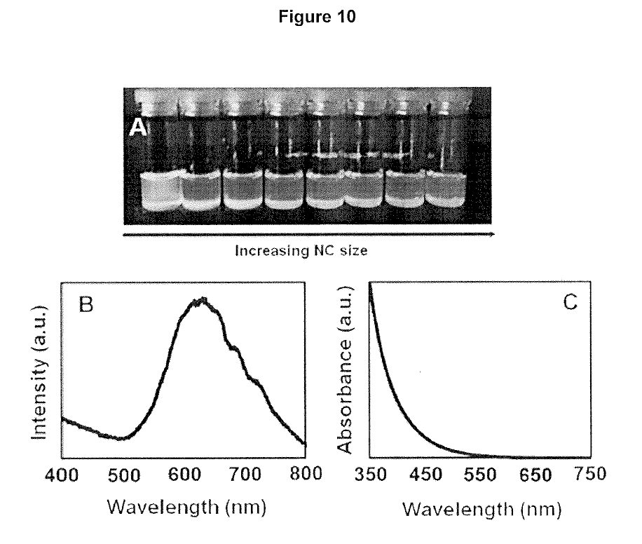

Photoluminescence (PL) studies were performed on TOPO functionalized Si-NCs and it was found that all particles exhibit red luminescence irrespective of particle size (FIG. 10). While not wishing to be limited by theory, it is believed that the PL is a surface emission. Attempts to remove excess TOPO from the solution led to precipitation of Si-NCs (in non-polar solvents) and quenching of the PL. While not wishing to be limited by theory, it is believed that excess TOPO is required to stabilize Si-NCs in organic layer as shown in FIG. 2. The PL also quenches in the presence of reagents capable of participating in hydrogen bonding (eg. amines and alcohols). The UV-Vis spectrum shows an absorption onset at ˜550 nm (FIG. 10C), typical of silicon nanocolloids.²²

While the present application has been described with reference to what are presently considered to be the preferred examples, it is to be understood that the application is not limited to the disclosed examples. To the contrary, the application is intended to cover various modifications and equivalent arrangements included within the spirit and scope of the appended claims.

All publications, patents and patent applications are herein incorporated by reference in their entirety to the same extent as if each individual publication, patent or patent application was specifically and individually indicated to be incorporated by reference in its entirety. Where a term in the present application is found to be defined differently in a document incorporated herein by reference, the definition provided herein is to serve as the definition for the term.

TABLE 1
Varying Stöber silica particle sizes with the reaction time and
respective reaction yields

| Reaction time (hours) | Particle size (nm) | Reaction yield (%) |
|---|---|---|
| 0.5 | 6.0 ± 0.5 | 72 |
| 1 | 15 ± 1 | 77 |
| 2 | 25 ± 3 | 74 |
| 5 | 40 ± 5 | 80 |
| 10 | 52 ± 5 | 74 |
| 24 | 75 ± 8 | 85 |
| 36 | 83 ± 10 | 82 |
| 48 | 95 ± 8 | 85 |
| 60 | 120 ± 10 | 88 |
| 72 | 145 ± 8 | 94 |
| 84 | 170 ± 10 | 90 |
| 100 | 200 ± 18 | 92 |

TABLE 2
Si-NCs sizes estimated from XRD and TEM

| Silica particle | | Si-NCs (XRD)^{a} | Si-NCs (TEM) | |
|---|---|---|---|---|
| 6.0 ± 0.5 | nm | 4 nm | 3.8 ± 0.4 | nm |
| 15 ± 1 | nm | 9 nm | 8.8 ± 0.6 | nm |
| 25 ± 3 | nm | 20 nm | 23 ± 2 | nm |
| 40 ± 5 | nm | 32 nm | 35 ± 5 | nm |
| 52 ± 5 | nm | 45 nm | 45 ± 5 | nm |
| 75 ± 8 | nm | 70 nm | 67 ± 8 | nm |
| 83 ± 10 | nm | Bulk | 75 ± 7 | nm |
| 95 ± 8 | nm | Bulk | 88 ± 8 | nm |
| 120 ± 10 | nm | Bulk | 110 ± 15 | nm |
| 145 ± 8 | nm | Bulk | 132 ± 12 | nm |
| 170 ± 10 | nm | Bulk | 150 ± 20 | nm |
| 200 ± 18 | nm | Bulk | 177 ± 20 | nm |

^{a}Scherrer analysis was used to estimate crystallite size from XRD data. L = (Kλ)/(Bcosθ) where: L = crystallite size, K = 0.9 (Scherrer constant), B = full width half max of the peak at 2θ, λ = 1.54 Å.

¹S. Ossicini, L. Pavesi and F. Priolo, Light Emitting Silicon for Microphotonics, Springer, Berlin, 2003.
²N. H. Alsharif, C. E. M. Berger, S. S. Varansai, Y. Chao, B. R.Horrocks and H. K. Dutta, Small, 2008, 5, 221.
³A. Meldrum, R. F. Haglund, L. A. Boatner and C. W. White, Adv. Mater., 2001, 13, 1431.
⁴U. Kahler and H. Hofmeister, Opt. Mater., 2001, 17, 83.
⁵F. Gorbilleau, X. Portier, C. Ternon, P. Voivenel, R. Madelon and R. Riszk, Appl. Phys. Lett., 2001, 78, 3058.
⁶D.Mayeri, B. L. Phillips, M. P. Augustine and S. M. Kauzlarich, Chem. Mater., 2001, 13, 765.
⁷A. Shiohara, S. Hanada, S. Prabhakar, K. Fujioka, T. H. Lim, K. Yamamoto, P. T. Northcote and R. D. Tilley, J. Am. Chem. Soc., 2010, 132, 248.
⁸J. D. Holmes, K. J. Ziegler, R. C. Doty, L. E. Pell, K. P. Johnston and B. A. Korgel, J. Am. Chem. Soc., 2001, 123, 3743.
⁹C. M. Hessel, E. J. Henderson and J. G. C. Veinot, Chem. Mater., 2006, 18, 6139.
¹⁰E. J. Henderson, J. A. Kelly and J. G. C. Veinot, Chem. Mater., 2009, 21, 5426.
¹¹M. Pauthe, E. Bernstein, J. Dumas, L. Saviot, A. Pradel and M. Riber, J. Mater. Chem., 1999, 9, 187.
¹²C. M. Hessel, D. Reid, M. G. Panthani, M. R. Rasch, B. W. Goodfellow, J. Wei, H. Fuji, V. Akhavan and B. A. Korgel, Chem. Mater., 2012, 24, 393.
¹³M. Dasog and J. G. C. Veinot, Chem. Commun., 2012, 48, 3760.
¹⁴D. P. Wong, H.-T. Lien, Y.-T. Chen, K.-H. Chen and L.-C. Chen, Green Chem., 2012, 14, 896.
¹⁵M.-P. Liu, C.-H. Li, H.-B. Du and X.-Z. You, Chem. Commun., 2012, 48, 4950.
¹⁶Z. Bao, M. R. Weatherspoon, S. Shian, Y. Cai, P. D. Graham, S. M. Allan, G. Ahmad, M. B. Dickerson, B. C. Church, Z. Kang, H. W. Abernathy, C. J. Summers, M. Liu and K. H. Sandhage, Nature, 2007, 446, 172.
¹⁷K. Kravitz, A. Kamyshny, A. Gedanken and S. Magdassi, Journal of Solid State Chemistry, 2010, 183, 1442.
¹⁸M. Dasog and J. G. C. Veinot, physica status solidi (a), 2012, 209, 1844-1846.
¹⁹K. Nozawa, H. Gailhanou, L. Raison, P. Panizaa, H. Ushiki, E. Sellier, J. P. Delville and M. H. Delville, Langmuir, 2005, 21, 1516.
²⁰U. Schubert and N. Husing, Synthesis of Inorganic Materials, Wiley-VCH, Weinheim, 2000, Ch. 2, pg 8.
²¹T. H. Chan and A. Melnyk, J. Am. Chem. Soc., 1970, 92, 3718.
²²Y. Zhu and L.D. Zhang, J. Phys.: Condens. Matter, 1999, 11, L491.

1. A method of preparing silicon nanocrystals (Si-NCs), the method comprising:
(a) combining silica particles with magnesium; and
(b) heating the combination in step (a) under conditions to form Si-NCs,
wherein the silica particles are obtained using sol gel chemistry.

2. The method of claim 1, wherein the conditions to form Si-NCs comprise a temperature of about 450 ° C. to about 650 ° C. and a time of about 6 hours to about 24 hours.

3. The method of claim 1, wherein the silica particles are Stöber silica particles.

4. The method of claim 3, wherein the Stöber silica particles have a particle size of about 5 nm to about 1 μm.

5. The method of claim 4, wherein the Stöber silica particles have a particle size of about 6 nm to about 200 nm.

6. The method of claim 5, wherein the Stöber silica particles have a particle size of about 6 nm, about 15 nm, about 25 nm, about 40 nm, about 52 nm, about 75 nm, about 83 nm, about 95 nm, about 120 nm, about 145 nm, about 170 nm or about 200 nm.

7. The method of claim 1, wherein the magnesium is magnesium powder.

8. The method of claim 7, wherein the molar ratio of the Stöber silica particles based on Si to the magnesium powder is from about 1:2 to about 1:3.

9. A method of preparing hydride terminated Si-NCs, the method comprising treating Si-NCs prepared by the method of claim 1 with hydrofluoric acid under conditions to form hydride terminated Si-NCs.

10. The method of claim 9, wherein the conditions to form hydride terminated Si-NCs comprise stirring a suspension of Si-NCs in an about 1:1:1 solution of about 49% HF(_{aq}):H₂O:ethanol for a time of about 60 minutes.

11. The method of claim 9, wherein the Si-NCs have a particle size estimated by X-ray diffraction of about 4 nm to about 70 nm.

12. The method of claim 11, wherein the Si-NCs have a particle size estimated by X-ray diffraction of about 4 nm to about 70 nm.

13. The method of claim 12, wherein the Si-NCs have a particle size estimated by X-ray diffraction of about 4 nm, about 9 nm, about 20 nm, about 32 nm, about 45 nm or about 70 nm.

14. The method of claim 9, wherein the Si-NCs have a particle size estimated by transmission electron microscopy of about 4 nm to about 1 μm.

15. The method of claim 14, wherein the Si-NCs have a particle size estimated by transmission electron microscopy of about 3.8 nm to about 177 nm.

16. The method of claim 15, wherein the Si-NCs have a particle size estimated by transmission electron microscopy of about 3.8 nm, about 8.8 nm, about 23 nm, about 35 nm, about 45 nm, about 67 nm, about 75 nm, about 88 nm, about 110 nm, about 132 nm, about 150 nm or about 177 nm.

17. A method of preparing hydroxyl-terminated Si-NCs functionalized with a trialkylphosphine oxide, the method comprising treating hydride terminated Si-NCs prepared by the method of claim 9 with a suitable trialkylphosphine oxide under conditions to form hydroxyl-terminated Si-NCs functionalized with a trialkylphosphine oxide.

18. The method of claim 17, wherein the conditions to form hydroxyl-terminated Si-NCs functionalized with a trialkylphosphine oxide comprise treating the hydride terminated Si-NCs with an excess amount of a suitable trialkylphosphine oxide at a temperature of about 25° C. for a time of about 12 hours.

19. The method of claim 18, wherein the trialkylphosphine oxide is a tri(C₆-C₁₂alkyl)phosphine oxide.

20. The method of claim 19, wherein the tri(C₈-alkyl)phosphine oxide is trioctylphosphine oxide.
